(19) United States
(12) Patent Application Publication
(10) Pub. No.: US 2021/0355957 A1
(43) Pub. Date: Nov. 18, 2021

(54) CENTRIFUGAL FAN AND ROTATING ELECTRICAL MACHINE

(71) Applicant: Mitsubishi Electric Corporation, Tokyo (JP)

(72) Inventors: Keisuke TAKEISHI, Tokyo (JP); Hiroyuki Higashino, Tokyo (JP); Shungo Miyagi, Tokyo (JP); Daisuke Sasaki, Tokyo (JP)

(73) Assignee: Mitsubishi Electric Corporation, Tokyo (JP)

(21) Appl. No.: 17/210,662

(22) Filed: Mar. 24, 2021

(30) Foreign Application Priority Data
May 12, 2020 (JP) 2020-083718

(51) Int. Cl. F04D 29/28; F04D 25/06; F04D 29/42

(52) U.S. Cl. CPC F04D 29/281; F04D 29/4213; F04D 25/06

(57) ABSTRACT

An air flow in an axial direction of a centrifugal fan is caused to increase.

A centrifugal fan included in a rotating electrical machine or the like is configured of a main plate having a multiple of plate-form blades provided in a ring form in a periphery of an axis of rotation and formed in a range such that a diameter increases heading from a front to a rear in a direction of rotation. The blade is provided erected from an arm-form plate projecting on an outer diameter side of a flat face portion of the main plate, at least one of the multiple of blades has a curved portion in one portion of a face portion configuring the blade, and a region of the blade in which the curved portion is provided is formed in a form pushed down to the front in the direction of rotation.

### BACKGROUND OF THE INVENTION

### 1. Field of the Invention

The present application relates to a centrifugal fan and a rotating electrical machine.

### 2. Description of the Related Art

A centrifugal fan is used as a constituent component of a rotating electrical machine such as a vehicle-mounted alternating current generator. Various blade forms have been proposed for an existing centrifugal fan, with an object of improving air flow characteristics and reducing noise.

For example, an example wherein a blade used as a cooling fan of an alternating current generator is such that a metal plate is formed in a bent form so as to be at a predetermined angle with respect to a main plate has been disclosed (for example, refer to Patent Literature 1).

Also, reducing noise by supports of a casing that houses an impeller as an existing centrifugal fan being arranged at differing intervals in a circumferential direction has been disclosed (for example, refer to Patent Literature 2).

Patent Literature 1: JP-A-9-154256

Patent Literature 2: Japanese Patent No. 5727833

The cooling fan blade disclosed in Patent Literature 1 is of a form wherein an end portion of a main plate is bent at a predetermined angle, because of which there is a case wherein an axial direction air flow increases, but an overall air flow and a centrifugal direction air flow are limited.

Also, the centrifugal fan disclosed in Patent Literature 2 is such that although noise can be reduced as an advantage of casing transformation, a multiple of fans are of the same form, and there is no mention of air flow characteristic improvement owing to blade form transformation.

### SUMMARY OF THE INVENTION

The present application has been devised in order to resolve the heretofore described kinds of problem, and has an object of obtaining a centrifugal fan such that air flow characteristics can be regulated, and cooling properties improved, by transforming a blade form, and of obtaining a rotating electrical machine that includes the centrifugal fan.

A centrifugal fan disclosed in the present application includes a main plate having a multiple of plate-form blades provided in a ring form in a periphery of an axis of rotation and formed in a range such that a diameter increases heading from a front to a rear in a direction of rotation, and is characterized in that the blade is provided erected from a flat face portion of the main plate, at least one of the multiple of blades has a curved portion in one portion of a face portion configuring the blade, and a region of the blade in which the curved portion is provided is of a form pushed down to the front in the direction of rotation.

Also, a rotating electrical machine disclosed in the present application is a rotating electrical machine in which the centrifugal fan is attached to one end of a rotor, and is characterized in that the flat face portion of the main plate is disposed on an axial direction end portion of a field core configuring the rotor so that the blade is positioned on an outer side, and the curved portion of the blade is disposed so as to overlap in the axial direction in an outer edge region of a gap portion between claw-form magnetic poles configuring the field core.

According to the centrifugal fan disclosed in the present application, an axial direction air flow can be caused to increase by a curved portion being provided in a blade, and by one portion of the blade being of a form pushed down to the front in a direction of rotation, because of which air flows in the axial direction and a centrifugal direction of the blade can be regulated, and cooling properties can be improved.

Also, the rotating electrical machine disclosed in the present application is such that by the centrifugal fan being attached to a rotor, an air flow fed in an axial direction of the rotor can be caused to increase, and a cooling performance can be improved.

The foregoing and other objects, features, aspects, and advantages of the present application will become more apparent from the following detailed description of the present application when taken in conjunction with the accompanying drawings.

### BRIEF DESCRIPTION OF THE DRAWINGS

FIG. 1 is a perspective view of a centrifugal fan according to a first embodiment;

FIG. 2 is a characteristic diagram wherein a performance of the centrifugal fan of the first embodiment is contrasted with that of comparative examples;

FIG. 3 is a main portion enlarged view of a centrifugal fan according to a second embodiment;

FIG. 4 is a sectional view of a blade of a centrifugal fan of a third embodiment;

FIG. 5 is a sectional view of a blade of a centrifugal fan of a fourth embodiment;

FIG. 6 is a main portion perspective view of a blade of a centrifugal fan of a fifth embodiment;

FIG. 7 is a main portion perspective view of the blade of the centrifugal fan of the fifth embodiment;

FIG. 8 is a sectional view showing a rotating electrical machine of a seventh embodiment; and

FIG. 9 is a side view showing a field core of the rotating electrical machine of the seventh embodiment.

### DETAILED DESCRIPTION OF THE PREFERRED EMBODIMENTS

### First Embodiment

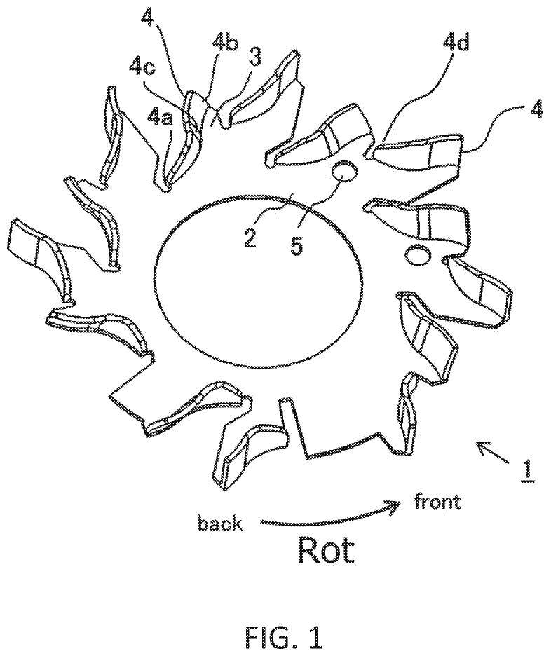

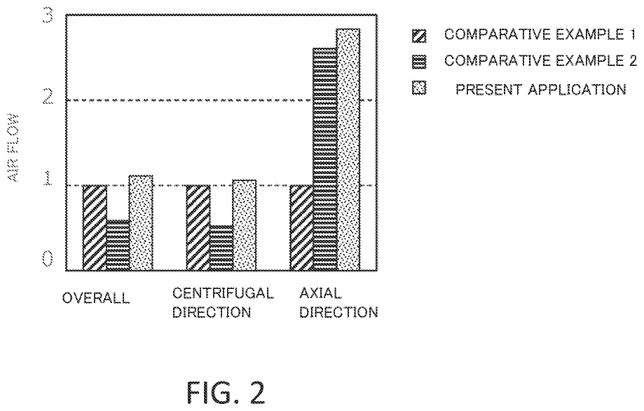

A centrifugal fan 1 according to a first embodiment of the present application will be described, using FIGS. 1 and 2. FIG. 1 is a perspective view of the centrifugal fan 1, wherein the centrifugal fan 1 is used in, for example, a vehicle-use rotating electrical machine 100, and a blade 4 is disposed so as to project to an axial direction outer side on an axial direction end face of a rotor 8 (to be described hereafter). FIG. 2 is a characteristic diagram wherein performances of the centrifugal fan 1 of the present application and comparative examples are compared.

As shown in FIG. 1, the centrifugal fan 1 is mainly configured of a main plate 2 provided in a ring form on a periphery of a through hole through which a shaft 34 (to be described hereafter) of the rotating electrical machine 100 is inserted. The main plate 2 has a multiple of blades 4 formed in a range wherein diameters increase from front to rear in a direction of rotation. The blade 4 is provided erected from an arm-form plate 3 projecting in an arm-form on an outer peripheral side of a flat face portion of the main plate 2. The arm-form plate 3 is one portion of the main plate 2, as heretofore described, and is provided in a flat plate form extended to a radial direction outer side from an outer peripheral portion of the flat face portion of the main plate 2. An angle at which the blade 4 is erected from the flat face portion of the main plate 2 can be, for example, a vertical angle (or an approximately vertical angle).

At least one of the multiple of blades 4 positioned in an end portion of the main plate 2 has a curved portion 4c in one portion of a face portion (blade face) configuring the blade 4, and a region in which the curved portion 4c of the blade 4 is provided is of a form pushed down to the front in the direction of rotation. Herein, the region in which the curved portion 4c is provided in the blade 4 is such that, unlike other portions of the blade 4, a partial curved face form is formed, whereby the region configures an inclined face.

As shown in FIG. 1, an aperture portion 5 that penetrates in the axial direction is provided on a radial direction inner side of the blade 4 in one of the multiple of arm-form plates 3 included in the centrifugal fan 1.

Also, in the example of FIG. 1, fourteen arm-form plates 3 are disposed in the circumferential direction. A stepped portion may be formed on an inner periphery of the through hole in the center of the main plate 2.

As shown in the example in FIG. 1, the fourteen arm-form plates 3 are disposed at varying intervals in the circumferential direction on the flat face portion of the main plate 2. Radial direction dimensions of the arm-form plate 3 are formed to be small on the front side in a direction of rotation Rot and large on the rear side in the direction of rotation Rot.

Also, arm-form plates 3 wherein a distance from a center of rotation O to a radial direction outer edge portion differs exist among the multiple of arm-form plates 3, and distances from the centers of rotation O of the blades 4 also vary. Although the curved portion 4c for causing an axial direction air flow to increase is selectively provided in the blade 4, disposing the curved portion 4c in the blade 4 wherein the distance from the center of rotation O is short is more advantageous in improving cooling properties.

As shown in FIG. 1, the blade 4 is configured in one plate form wherein a rear edge portion 4b positioned on the rear side in the direction of rotation (this may also be the radial direction outer side) and a front edge portion 4a positioned on the front side in the direction of rotation (this may also be the radial direction inner side) are integrated.

A distance from the center of rotation O of the centrifugal fan 1 to the rear edge portion 4b of the blade 4 is greater than a distance from the center of rotation O to the front edge portion 4a of the blade 4.

Also, a form of the blade 4 projected onto a face perpendicular to the axis can approximate an arc having a gentle curve, and the arc is formed so as to protrude on the center of rotation O side with respect to a line that joins the front edge portion 4a and the rear edge portion 4b.

Herein, with an object of reducing an air cutting noise caused by the front edge portion 4a when the centrifugal fan 1 rotates, there is a case wherein the front edge portion 4a of the blade 4 is caused to incline in a direction toward the center of rotation O or to the rear in the direction of rotation.

The centrifugal fan 1 configured of the main plate 2 having the blade 4 in this way causes an air flow that flows to the radial direction outer side (in the centrifugal direction) along the blade 4 to be generated. By so doing, the centrifugal fan 1 converts an air flow heading toward a central portion of the main plate 2 into an air flow that heads toward the radial direction outer side. The form of the main plate 2 is not limited to a ring form, and a stepped portion need not be provided in the inner peripheral portion. Furthermore, the central portion of the main plate 2 may be a form that is raised up in a bowl form. Also, the number of arm-form plates 3, not being limited to fourteen, may be four or more, or may be an odd number. Furthermore, the multiple of arm-form plates 3 may be disposed at equal intervals, and a reinforcing rib may be provided on each arm-form plate 3.

Further, the form of the blade 4 projected onto the face perpendicular to the axis may be linear or S-shaped, or the forms of the blades 4 may be caused to differ. Furthermore, the blade 4 may be caused to project from a position toward the center of the flat face rather than from an outer peripheral end of the arm-form plate 3. Also, a circular shroud may be disposed on the radial direction outer side of the blade 4.

Other than the circular form shown in FIG. 1, a different form such as an elliptical form or a polygonal form may be adopted for the aperture portion 5. Also, in order to reduce resistance added to an air flow that passes through the aperture portion 5, and restrict a decrease in a flow speed of air that flows in the axial direction, a round form or a chamfered round form may be formed in an edge portion of the aperture portion 5.

Furthermore, as it is sufficient that the aperture portion 5 is disposed in the flat face portion of the main plate 2, the aperture portion 5 can be disposed in a region other than the arm-form plate 3.

Also, when two neighboring arm-form plates 3 are in proximity to each other, the two arm-form plates 3 may be integrated, and the aperture portion 5 may be formed in the integrated arm-form plate 3.

Although an example wherein two apertures 5 are provided in the main plate 2 is shown in FIG. 1, the number of apertures 5 can be adjusted, and the number maybe one, one maybe provided in each arm-form plate 3, or one maybe provided in every other arm-form plate 3 disposed sequentially on the periphery. Furthermore, a multiple of apertures 5 may be provided in one arm-form plate 3, and the forms of the aperture portions 5 may be caused to differ variously.

By increasing the apertures 5, thereby reducing weight, a center of gravity of the centrifugal fan 1 becomes nearer to the center of rotation O, because of which rotation of the centrifugal fan 1 can be stabilized. In this case, the disposition, the number, and the size of the aperture portions 5 provided in each arm-form plate 3 may be determined with consideration to a circumferential direction weight balance of the centrifugal fan 1.

The centrifugal fan 1 of the present application is such that the outer side of the blade 4 is a positive pressure face (a face on the front side in the direction of rotation) that generates an air flow, and the inner side of the blade 4 is a negative pressure face (a face on the rear side in the direction of rotation). Also, axial direction dimensions (standing heights) of the blade 4 are such that the front edge portion 4a in the direction of rotation is small, and the rear edge portion 4b is large, whereby a collision of air in the front edge portion 4a is restricted. That is, as shown by a front edge side upper end portion 4d of the blade 4 in FIG. 1, an amount by which the front edge side upper end portion 4d projects in the axial direction from the main plate 2 (the arm-form plate 3) is kept small, whereby the air cutting noise can be reduced further than in other portions of the blade 4.

In this kind of centrifugal fan 1, at least one blade 4 is such that the curved portion 4c is formed in one portion of the face portion configuring the blade 4, and the region of the blade 4 in which the curved portion 4c is provided is of a form pushed down by a twist being applied to the front in the direction of rotation. Herein, the curved portion 4c refers to a portion that is formed in, for example, the face portion that forms the positive pressure face of the blade 4, and whose curvature radius varies in the axial direction. There is a case wherein the curved portion 4c is formed to spread in the radial direction and the axial direction along the face portion of the blade 4.

In the example of the first embodiment, the curved portion 4c is provided in the rear edge portion 4b, which is the rear of the blade 4 in the direction of rotation, or on an outer diameter side of the blade 4. In this case, the outer diameter side of the blade 4 is provided curved so as to fall in the direction of rotation, and the positive pressure face of the blade 4 is provided in a form whose curvature radius becomes larger (curvature becomes smaller) heading from the outer diameter side to an inner diameter side. Because of this, the positive pressure face of the blade 4 forms a recessed curve in the rear edge portion 4b, and can cause an air flow flowing in the axial direction to increase.

The region in which the curved portion 4c is provided in the blade 4 of the centrifugal fan 1 in this way is such that the area of the blade 4 projected onto the face perpendicular to the axis increases owing to a twist being applied to the face portion of the blade 4, whereby an axial direction air flow can be caused to increase. This means that by carrying out an adjustment of the curvature and a formation range of the curved portion 4c, a balance can be struck between axial direction and radial direction air flows of the centrifugal fan 1, and a cooling performance can be caused to improve.

In the example of FIG. 1, the curved portion 4c is provided in every other one of the blades 4 aligned in the circumferential direction, but the curved portion 4c may be provided in one blade 4, the curved portion 4c may be provided in a multiple of blades 4 at varying intervals, or the curved portion 4c may be provided in each blade 4.

A bar graph of FIG. 2 is a characteristic drawing showing results of comparing overall, centrifugal direction, and axial direction cooling air flows of a first comparative example, which is a centrifugal fan to which the present application is not applied and in which the curved portion 4c is not provided in the blade 4, a second comparative example, whose structure is the same as that of the centrifugal fan of Patent Literature 1 and in which an angle of inclination of the blades is constant, and the centrifugal fan 1 (the present application in FIG. 2) , to which the blade 4 having the curved portion 4c of the present application is applied, with the first comparative example as a reference. The overall air flow represents a total of the centrifugal direction and axial direction airflows.

FIG. 2 shows that by applying the centrifugal fan 1 of the present application, the axial direction air flow can be caused to increase in comparison with the first and second comparative examples, without causing the centrifugal direction air flow to decrease, and the overall cooling air flow can be caused to increase.

### Second Embodiment

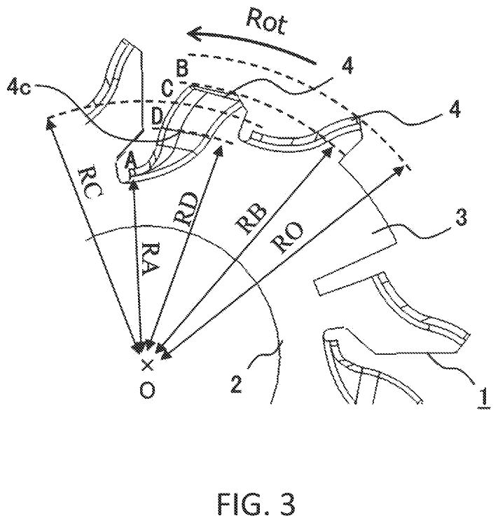

An example wherein the curved portion 4c is provided on the rear edge portion 4b side of the blade 4 is shown in the first embodiment, but in a second embodiment, a case wherein the curved portion 4c is provided farther to the inner diameter side of the blade 4 than the rear edge portion 4b will be described, using FIG. 3. In FIG. 3, a distance of the front edge portion 4a (a radial direction position is shown as a point A) of the blade 4 from the center of rotation O is RA, a distance of the rear edge portion 4b (a radial direction position is shown as a point B) of the blade 4 from the center of rotation O is RB, and a distance between a point C on the face portion, positioned between the front edge portion 4a and the rear edge portion 4b of the blade 4, and the center of rotation O is RC (RA<RC<RB). The point C indicates an intermediate position between the edge portions of the blade 4 in the direction of rotation and the radial direction.

In this case, the curved portion 4c is provided in at least one blade 4 between RA and RC, that is, farther to the inner diameter side of the blade 4 than the rear edge portion 4b, whereby one portion of the blade 4 is formed in a curved form. The radial direction position of the curved portion 4c is shown as a point D. A distance of the point D from the center of rotation O is shown as RD. By the curved portion 4c being provided in the position in the blade 4 indicated by the point D, a relationship RD<RC<RB is established.

Even when the curved portion 4c is provided in a position toward the inner diameter side of the blade 4, the axial direction air flow can be caused to increase more than when the curved portion 4c is not provided, and by employing this kind of configuration, an air cutting noise occurring in the front edge portion 4a of the blade 4 can be restricted.

Although a case wherein the rear edge portion 4b of the blade 4 in which the curved portion 4c is provided is of a diameter (RB) smaller than an outer diameter RO of the centrifugal fan 1 is shown in the example of FIG. 3, there is also a case wherein the curved portion 4c is formed so that the size of the blade 4 is that of the outer diameter RO. In this case, a relationship RD<RC<RO is established, and the axial direction air flow can be caused to increase while reducing air noise occurring due to the air flow.

### Third Embodiment

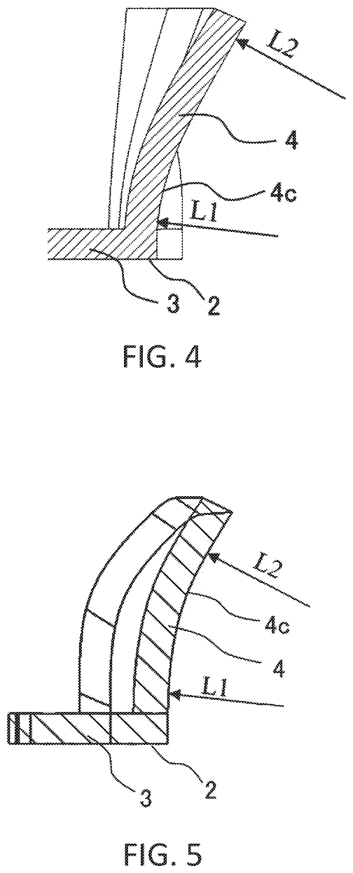

Examples wherein the disposition of the curved portion 4c in the radial direction of the blade 4 is on the rear edge portion 4b side and farther to the inner diameter side than the rear edge portion 4b are shown in the first and second embodiments. In a third embodiment, an example of a disposition of the curved portion 4c of the blade 4 in the axial direction will be described, using FIG. 4. FIG. 4 corresponds to a circumferential direction sectional view in the axial direction at the point C on the face portion of the blade 4 of FIG. 3. An inclined face of the blade 4 in which the curved portion 4c is provided is provided in a form whose curvature radius decreases (curvature gradually increases) as the inclined face heads in the axial direction from an end portion (on an intake side) of the blade 4 toward the flat face portion of the main plate 2. An intake side (L2) curvature radius of the end portion of the blade 4 is of a value greater than a flat face portion side (L1) curvature radius of the main plate 2.

By curvature being increased in a position in the blade 4 nearer to the flat face portion of the main plate 2 than to the end portion in this way, a flow of cooling air can be adjusted, and cooling properties can be caused to improve.

### Fourth Embodiment

A case wherein the curved portion 4c is provided in the blade 4, and the blade form is such that the curvature radius decreases heading from the intake side toward the flat face portion side of the main plate 2 in the axial direction, is shown as an example in the third embodiment. In a fourth embodiment, a case wherein the blade form is such that the curvature radius increases heading from the intake side toward the flat face portion side of the main plate 2 in the axial direction, which is the opposite of the blade form in the third embodiment, will be described using FIG. 5. When adopting a blade form curved so that the curvature radius gradually increases heading from the intake side (L2) toward the flat face portion side (L1) of the main plate 2, as shown in FIG. 5 in a circumferential direction sectional view of the blade 4 in the axial direction, the flow of cooling air can be adjusted, and cooling properties can be caused to improve.

A state wherein an inclined face with a large curvature is provided on the inner diameter side, which is a side farther to the rear of the blade 4 than the sectional portion, is shown in the example of FIG. 5.

### Fifth Embodiment

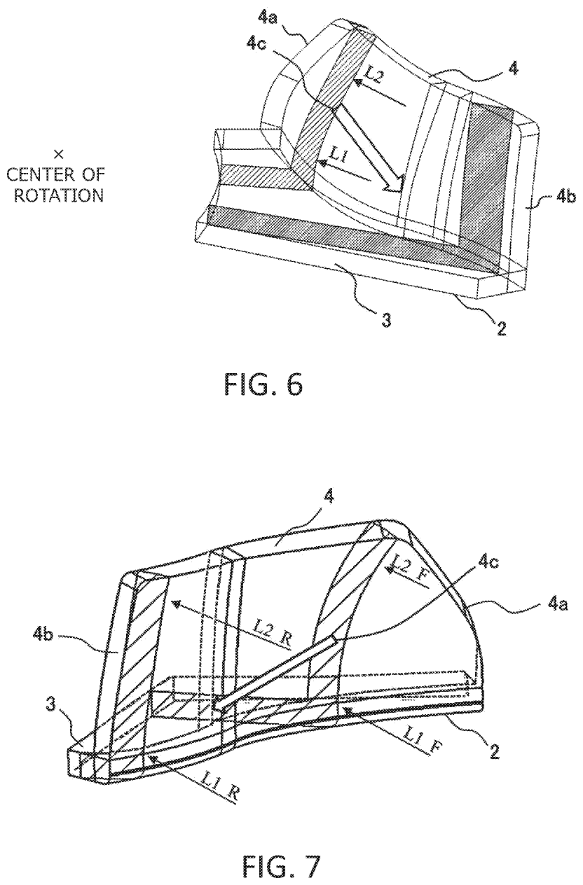

Also, FIGS. 6 and 7 show examples of a blade form of the centrifugal fan 1 according to a fifth embodiment of the present application. FIG. 6 is a main portion perspective view of the blade 4 of the centrifugal fan 1 wherein the negative pressure face of the blade 4 is shown on the front side, and shows a sectional view in the radial direction of two places in the blade 4, at the front and rear in the direction of rotation. FIG. 7 is a main portion perspective view of the blade 4 of the centrifugal fan 1 wherein the positive pressure face of the blade 4 is shown on the front side, and shows a sectional view in the circumferential direction of two places in the blade 4, at the front and rear in the direction of rotation. In FIG. 7, a reference sign (L2_F) indicating the intake side and a reference sign (L1_F) indicating the flat face portion side of the main plate 2 are entered in a cross-section near the front edge portion 4a, and a reference sign (L2_R) indicating the intake side and a reference sign (L1_R) indicating the flat face portion side of the main plate 2 are entered in a cross-section near the rear edge portion 4b. In each case, the curved portion 4c is provided in a comparatively wide range from the front edge portion 4a to the rear edge portion 4b of the face portion of the blade 4 so that the degree of curvature of the blade 4 is large on the side nearer to the front edge portion 4a, and the degree of curvature becomes smaller the nearer to the rear edge portion 4b.

As shown in FIGS. 6 and 7, the blade 4 is provided in a form such that a position in which the axial direction curvature radius of the blade 4 becomes smallest, heading from the front to the rear in the direction of rotation in the region in which the curved portion 4c is provided, shifts in a direction approaching the arm-form plate 3 (the flat face portion of the main plate 2) from the axial direction intake side of the blade 4. Although the direction of shift of the position in which the axial direction curvature radius becomes smallest is indicated by an arrow as the curved portion 4c, the place indicated by the arrow indicates the position in which the smallest value of the axial direction curvature radius is found, and it goes without saying that the state is such that a curved form is also formed in the face portion positioned in a periphery of the arrow.

By the curved portion 4c being provided in the blade 4 from the front to the rear in the direction of rotation in this way, and by the blade 4 being formed to have a form wherein the position in which the axial direction curvature radius becomes smallest nears the flat face portion of the main plate 2 heading from the front to the rear in the direction of rotation (as the distance from the center of rotation O increases) , a blade form wherein the curvature is caused to vary in the radial direction and the axial direction can be obtained, and rectification of the centrifugal fan 1 can be improved.

### Sixth Embodiment

The centrifugal fan 1 is of a configuration wherein the multiple of blades 4 are disposed in the circumferential direction, as heretofore described, but in a sixth embodiment, a description will be given of which blade 4 of the multiple of blades 4 the curved portion 4c being provided in is effective in improving the cooling properties.

An air flow received by the blade 4 of the centrifugal fan 1 tends to increase further the greater an interval with the blade 4 ahead positioned in front in the direction of rotation of the blade 4. This means that when an interval between end portions in front in the direction of rotation of each of two neighboring blades 4 in the centrifugal fan 1 is at a maximum, or when the interval reaches a predetermined value or greater and the air flow hitting the positive pressure face of the blade 4 increases, the air flow in the axial direction can be effectively caused to increase by the curved portion 4c being provided in the blade 4 positioned at the rear in the direction of rotation.

### Seventh Embodiment

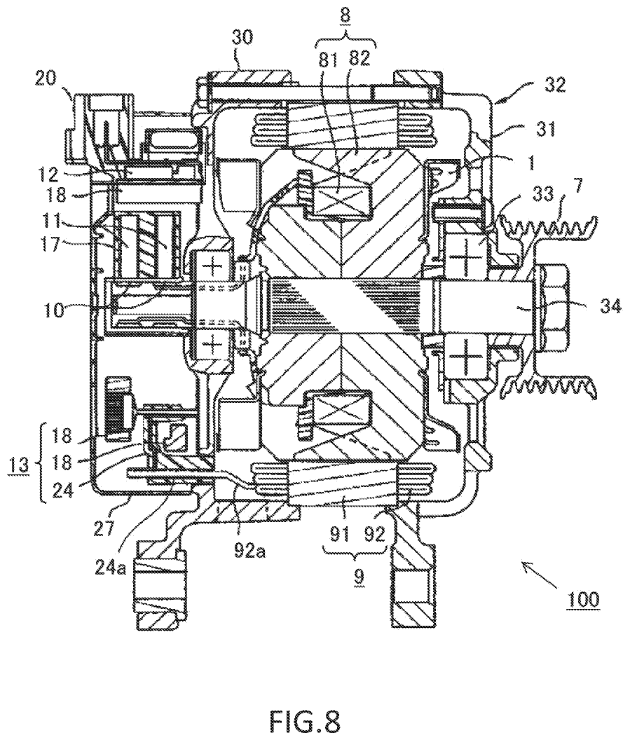

The centrifugal fan 1 disclosed in the first to sixth embodiments can be applied to the rotating electrical machine 100. For example, the centrifugal fan 1 may be utilized by being attached to the rotor 8 of the rotating electrical machine 100, which is a vehicle-mounted alternating current generator, a motor, a vehicle-mounted drive device, or the like. Herein, as one example, a vehicle-use alternating current generator is shown as the rotating electrical machine 100 to which the centrifugal fan 1 of the present application is applied. FIG. 8 is a sectional view of the rotating electrical machine 100 observed from a side.

In FIG. 8, the rotating electrical machine 100 has a casing 32 formed of a front side housing 31 and a rear side housing 30, each of which is of an approximate bowl form and made of aluminum. The rotating electrical machine 100 has the shaft 34, supported so as to be able to rotate by the casing 32 across a pair of bearings 33, and a pulley 7 fixed to an end portion of the shaft 34 projecting to a front side of the casing 32. The front side bearing 33 is supported by the front side housing 31, and the rear side bearing 33 is supported by the rear side housing 30.

Furthermore, the rotating electrical machine 100 has the rotor 8, which is disposed inside the casing 32 by being fixed to the shaft 34 and rotates integrally with the shaft 34, and a stator 9 fixed to the casing 32 so as to enclose the rotor 8. Also, the rotating electrical machine 100 has a pair of slip rings 10, which are fixed to a protruding portion of the shaft 34 protruding to a rear side of the casing 32 and supply current to the rotor 8, a pair of brushes 11, which are housed in a brush holder 17 and slide one each over surfaces of the slip rings 10, and a voltage regulator 12, which is disposed neighboring the pair of brushes 11 and regulates a magnitude of an alternating current voltage generated in the stator 9.

Further, the rotating electrical machine 100 has a rectifying device 13 that converts alternating current voltage generated in the stator 9 into direct current voltage, a connector 20 that carries out an exchange of signals between the voltage regulator 12 and an external device, and a protective cover 27 mounted on the rear side housing 30 so as to cover the voltage regulator 12, the rectifying device 13, and the brush holder 17.

The rotor 8 is a Lundell-type rotor, and has a field winding 81, through which an excitation current flows and which generates a magnetic flux, and a field core 82, which is provided so as to cover the field winding 81 by being fixed to the shaft 34, which penetrates in an axial position, and in which a magnetic pole is formed owing to a magnetic flux generated in the field winding 81.

The centrifugal fan 1 according to the first embodiment of the present application is disposed on a mounting face on the pulley 7 side of the rotor 8 or on a mounting face on the side opposite to the pulley 7.

The stator 9 is disposed coaxially in an outer periphery of the rotor 8. The stator 9 includes a cylindrical stator core 91 and a stator winding 92, mounted on the stator core 91, in which an alternating current is generated owing to a change in the magnetic flux from the field winding 81 in accompaniment to a rotation of the rotor 8. The stator core 91 is clamped from both sides in the axial direction between the front side housing 31 and the rear side housing 30. A lead wire 92a of the stator winding 92 is drawn out from the rear side housing 30, and connected to a terminal 24a of a circuit board 24. Because of this, the rectifying device 13 and the stator winding 92 are electrically connected. The rectifying device 13 includes a heatsink 18, on which a multiple of rectifying elements are mounted, and the circuit board 24.

The rotating electrical machine 100 configured in this way is such that rotational torque of an unshown engine is transmitted via the pulley 7 to the shaft 34, and the rotor 8 is rotated. At this time, current is supplied via the brush 11 and the slip ring 10 to the field winding 81 of the rotor 8, and magnetic flux is generated. Owing to the magnetic flux, N-poles and S-poles are formed alternately in a circumferential direction in a multiple of claw-form magnetic poles arrayed in an outer peripheral portion of the field core 82. Because of this, a rotating magnetic field is applied to the stator winding 92 of the stator 9, and an alternating current electromotive force is generated in the stator winding 92. The alternating current electromotive force is supplied to the rectifying device 13 via the lead wire 92a, and rectified in the rectifying device 13, in addition to which a magnitude thereof is regulated in the voltage regulator 12, and the alternating current electromotive force is supplied to a battery and a vehicle-mounted electrical component.

Herein, the centrifugal fan 1 fixed to the pulley 7 side of the field core 82 rotates owing to the rotor 8 rotating. Owing to the rotation of the centrifugal fan 1, external air is taken into an interior of the casing 32 from an aperture portion formed in the front side housing 31. The external air taken into the interior of the casing 32 flows in the axial direction inside the front side housing 31, reaching the field core 82, whereby front side coil ends of the field winding 81 and the stator winding 92 are cooled.

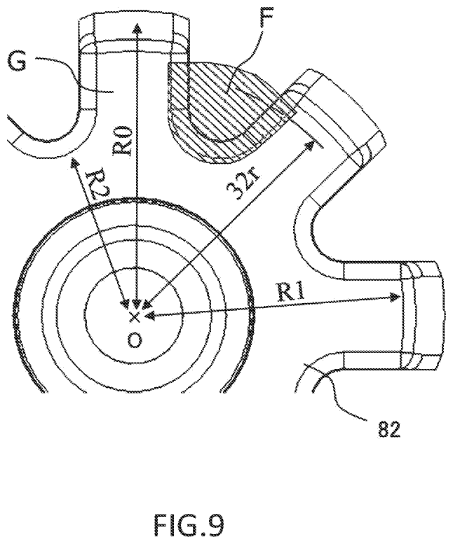

FIG. 9 is a drawing showing a side of the field core 82 of the rotating electrical machine 100 on which amounting face G of the centrifugal fan 1 is provided. The mounting face G of the centrifugal fan 1 is provided on a side opposite to a side on which eight claw-form magnetic poles provided on the field core 82 extend. A region F indicated by diagonal lines in FIG. 9 indicates a range within which cooling air can be caused to flow when effectively cooling the field winding 81, and corresponds to a region wherein a gap (or portion) provided between claw-form magnetic poles of the field core 82 is projected onto the centrifugal fan mounting face G.

When the centrifugal fan 1 is attached to the mounting face G, the axial direction air flow increases owing to overlapping of the curved portion 4c and the region F increasing in the axial direction. Meanwhile, when the curved portion 4c coincides with the mounting face G in the axial direction, the air flow collides with the field core 82, and an air cutting noise increases.

This means that by the curved portion 4c of the centrifugal fan 1 being provided in a portion overlapping the region F when projected onto the mounting face G, an air flow flowing in the axial direction can be caused to increase, and the field winding 81 can be effectively cooled, without causing a generated air cutting noise to increase.

Therefore, the capacity for cooling the coil ends of the field winding 81 of the field core 82 and the stator winding 92 can be increased. Because of this, a power output of the vehicle-mounted rotating electrical machine can be caused to increase.

Herein, by the arm-form portion 3 of the centrifugal fan 1 being superimposed on the mounting face G of the field core 82, and an erect portion of the blade 4 being disposed so as to coincide with an outer edge portion of a claw-form magnetic pole of the field core 82, the aperture portion that feeds cooling air in the axial direction can be secured with a large width. This means that by the flat face portion of the main plate 2 of the centrifugal fan 1 being disposed in an axial direction end portion of the field core 82 of the rotor 8 so that the blade 4 faces an outer side, and furthermore, by the curved portion 4c of the blade 4 being disposed so as to overlap in the axial direction in an outer edge region of a gap portion between the claw-form magnetic poles configuring the field core 82, or more specifically, at the rear in the direction of rotation of a V-shaped outer edge region, the air flow in the axial direction can be effectively caused to increase, while restricting an air cutting noise.

Also, for example, when a maximum outer diameter of the mounting face G of the centrifugal fan 1 is R1, as shown in FIG. 9, an air flow flowing in the axial direction can be more effectively caused to increase by the curved portion 4c of the centrifugal fan 1 being provided in a range within a radius R1 (farther to an inner diameter side than a maximum outer diameter portion) from the center of rotation O, and the field winding 81 can be effectively cooled. A region farther to the outer side than the radius R1 is a space necessary for allowing exhaust air that has cooled the field winding 81 to flow. Therefore, in order for air that has cooled the field winding 81 and become hot to be blown out in the axial direction, the curved portion 4c of the centrifugal fan 1 needs to be disposed in a region that does not impede an exhaust air flow and that is farther to the inner diameter side than R1, and by the curved portion 4c being disposed in a region that is farther to the inner diameter side than R1, properties of cooling the field winding 81 can be improved, while restricting an air cutting noise. In FIG. 9, a minimum outer diameter of the mounting face G is shown as R2, and a maximum outer diameter of the field core 82 is shown as R0.

Furthermore, a maximum opening diameter of an intake hole of the casing 32 is shown as a casing intake outer diameter 32r in FIG. 9. In the axial direction, an edge portion of the intake hole of the casing 32 coincides with a circle having the casing intake outer diameter 32r as a radius. In a plane perpendicular to the axis, the curved portion 4c of the centrifugal fan 1 is provided farther to the inner side than the edge portion of the intake hole of the casing 32, that is, on an inner side of a circle having a radius smaller than the casing intake outer diameter 32r, whereby an air flow disturbance occurring at the intake hole of the casing 32 can be kept small, because of which the air flow in the axial direction can be effectively caused to increase, and the field winding 81 can be more effectively cooled, while restricting an air cutting noise.

Although the present application is described above in terms of various exemplifying embodiments and implementations, it should be understood that the various features, aspects, and functions described in one or more of the individual embodiments are not limited in their applicability to the particular embodiment with which they are described, but instead can be applied, alone or in various combinations, to one or more other embodiments.

It is therefore understood that numerous modifications that have not been exemplified can be devised without departing from the scope of the present application. For example, at least one constituent component may be modified, added, or eliminated. At least one of the constituent components mentioned in at least one of the preferred embodiments may be selected and combined with the constituent components mentioned in another preferred embodiment.

What is claimed is:

1. A centrifugal fan, comprising a main plate having a multiple of plate-form blades provided in a ring form in a periphery of an axis of rotation and formed in a range such that a diameter increases heading from a front to a rear in a direction of rotation, wherein
the blade is provided erected from a flat face portion of the main plate,
at least one of the multiple of blades has a curved portion in one portion of a face portion configuring the blade, and
a region of the blade in which the curved portion is provided is of a form pushed down to the front in the direction of rotation.

2. The centrifugal fan according to claim 1, wherein the curved portion is provided in a back edge portion positioned on an outer diameter side of the blade.

3. The centrifugal fan according to claim 1, wherein the curved portion is provided farther to an inner diameter side than a back edge portion positioned on an outer diameter side of the blade.

4. The centrifugal fan according to claim 1, wherein a region in which the curved portion of the blade is provided is provided in a form such that a curvature radius decreases heading in an axial direction from an end portion of the blade toward the flat face portion of the main plate.

5. The centrifugal fan according to claim 1, wherein a region in which the curved portion of the blade is provided is provided in a form such that a curvature radius increases heading in an axial direction from an end portion of the blade toward the flat face portion of the main plate.

6. The centrifugal fan according to claim 1, wherein the curved portion of the blade is provided from the front to the rear in the direction of rotation, and
the blade is formed in a form such that a position in which the curvature radius in the axial direction is smallest nears the flat face portion of the main plate while heading from the front to the rear of the blade in the direction of rotation.

7. The centrifugal fan according to claim 1, wherein, when an interval between end portions in the front in the direction of rotation of two neighboring blades is at a maximum, the curved portion is provided in the blade positioned at the rear in the direction of rotation.

8. A rotating electrical machine in which the centrifugal fan according to claim 1 is attached to one end of a rotor, wherein
the flat face portion of the main plate is disposed on an axial direction end portion of a field core configuring the rotor so that the blade is positioned on an outer side, and
the curved portion of the blade is disposed so as to coincide in the axial direction with an outer edge region of a gap portion between claw-form magnetic poles configuring the field core.

9. The rotating electrical machine according to claim 8, wherein the curved portion of the blade is disposed farther to an inner diameter side than a maximum outer diameter portion of a mounting face of the field core.

10. The rotating electrical machine according to claim 8, wherein the curved portion of the blade is provided farther to an inner diameter side than an edge portion of an intake hole of a casing enclosing the centrifugal fan.
